(19) United States
(12) Patent Application Publication
(10) Pub. No.: US 2013/0164723 A1
(43) Pub. Date: Jun. 27, 2013

(54) TRAINING APPARATUS

(71) Applicant: Kemal Sakinc, Munster (DE)

(72) Inventor: Kemal Sakinc, Munster (DE)

(21) Appl. No.: 13/518,877

(22) PCT Filed: Dec. 22, 2010
(86) PCT No.: PCT/EP2010/070602

§ 371 Date: Sep. 4, 2012

(30) Foreign Application Priority Data
Dec. 23, 2009 (DE) 10 2009 059 297.0

(51) Int. Cl. G09B 19/00

(52) U.S. Cl. CPC G09B 19/00
USPC 434/247

(57) ABSTRACT

A training apparatus is provided for sports exercises, in particular for running exercises, with a plurality of obstacle parts each individually arranged in the extension direction of the training apparatus, additionally has an adjustment mechanism for in particular manually adjusting the distance, seen in the extension direction, between an obstacle part and at least one further adjacent obstacle part. The adjustment mechanism has at least one connection element, which interconnects all the obstacle parts or at least two mutually adjacent obstacle parts. The connection element is preferably composed of an elastically deformable cable, in particular a rubber cable or rubber band, wherein each connection element can be designed, in terms of its length or elastic deformability, identically to or different from another connection element. The distances between the obstacle parts, seen in the extension direction, are substantially constant or deviate from one another. On each obstacle part, there is a receiving device for a connection element of the adjustment mechanism, by means of which receiving device the obstacle part is connected permanently or releasably to the connection element, for example by knots, a hook-and-loop connection, a hook and eye connection, a carabiner connection, a press-button connection or the like.

### BACKGROUND AND SUMMARY

The invention relates to a training apparatus for sports exercises, in particular for running exercises, with a plurality of obstacle parts, each individually arranged in the extension direction of the training apparatus, wherein the training apparatus additionally has an adjustment mechanism for in particular manually adjusting the distance A, viewed in the extension direction, between an obstacle part to at least one further adjacent obstacle part and the adjustment mechanism is at least one connection element which interconnects all the obstacle parts or at least two reciprocally adjacent obstacle parts.

Such training apparatuses are known from the sector of athletics, in particular running training. In this instance, the obstacle parts are arranged in the form of automotive tires or Hula hoops in the extension direction to be negotiated by the users.

In addition, training apparatuses are known in which the obstacle parts are slalom pylons which have to be negotiated.

With the two known training apparatuses it also occurs as part of the training that an obstacle part will be pushed over by the users or is shifted transverse to the extension direction of the training apparatus. This requires at least this obstacle part to be realigned, which interferes with the training sequence and is inconvenient.

In addition this has proven to be time-consuming as well as interfering with the training sequence, so that the obstacle parts during advanced training, such as when changing the step width, must be repositioned again.

A training apparatus for horses is known from U.S. Pat. No. 6,263,835 B1, in which vertical posts arranged in pairs, with respectively one obstacle rail which can be adjusted vertically transverse to the running direction, can be fixed on mounting rails, wherein the mounting rails are configured and/or are arranged in the running direction. The distance between consecutively following pairs of posts, each of which support an obstacle rail, can be varied and predetermined along the mounting rails.

A modular designed training apparatus is known from DE 27 29 025 A1, in which posts that are reciprocally arranged in pairs can each also be interconnected with an obstacle by connection elements installed on the floor. By selecting the connection elements used in each case from several connection elements of different length, the distance of pairs of posts which are following consecutively can be predetermined.

With both these training apparatuses, the distance of consecutive obstacles must be predetermined manually in each case. The obstacles can either detach from the posts or be designed elastically, in order to prevent injuries, in case that a user collides with an obstacle during the training. The distance between individual consecutive obstacles can only be changed with great difficulty.

A training apparatus of the species mentioned at the outset is known from U.S. Pat. No. 5,842,954 B, in which two adjacently arranged bars are supported on posts. Obstacles can be positioned and optional intervals between the two bars. The obstacles can be tapes, the end loops of which wrap around both ends of the bars and which have a disconnect in the center with a detachable connection of the two tape sections. Should a user bump against an obstacle tape, then the connection would detach and clear the space between the bars in order to prevent injuries to the user.

The obstacle tapes must be manually arranged along the bars also in this training apparatus. Should an obstacle tape be touched and displaced along the bars, or even be severed during the training, then the respective obstacle tape must be rearranged and aligned again along the bars. To change the distance between consecutive obstacle tapes, all obstacle tapes must be rearranged and realigned in each case, which involves significant effort and which means that an interruption of the training sequence is unavoidable.

The purpose of the invention is to propose a training apparatus where the interferences with the training sequence is reduced.

This object is achieved by a training apparatus as taught by the invention, in which the connection element is formed by at least one, preferably elastic ductile rubber cord or rubber tape.

It is conceivable, for example, that all obstacle parts are interconnected by the same rubber cord, wherein this is connected with the obstacle parts such that a distance between the obstacle parts to one another is adjustable by means of tensioning the rubber cord, for example. The invention teaches that the same effect can also be accomplished with multiple connection elements, however, such as if a separate rubber cord is arranged between the obstacle pails in each case.

If a user bumps against an obstacle parts during the training sequence, then the respective obstacle part will be displaced briefly through the contact with the user, but it will subsequently be retracted by the rubber cord into the starting position again. A manual rearrangement or alignment is not required.

In the same manner, the spaces between the individual obstacle parts can be changed uniformly, in that the length of the rubber cord with the obstacle parts attached to it is extended or the ends of the rubber cord are adjusted with a smaller space in between. The individual obstacle parts respectively assume the assigned new position along the rubber cord, without the need for having to rearrange or realign the obstacle parts individually in each case.

In addition, it proves to be advantageous if the adjustment mechanism has at least two rubber cords running in parallel, which are preferably connected on the ends of each obstacle part with same, when viewed in the longitudinal direction. In this manner, the obstacle parts relative to the alignment of their longitudinal axes are fixed transverse to the extension direction.

In addition, it proves to be advantageous if the distance between the obstacle parts to one another, viewed in the extension direction, is essentially constant. It can thus be useful in order to train for a certain step width, for example, that the obstacle parts have a constant distance between each other. On the other hand it may be desirable to have varying and/or alternating distances for coordinated ability training. Depending on the requirement, the distance between adjacent obstacle parts can vary or be the same section by section and change from section to section.

The connection elements can be tied around the obstacle parts and be knotted, for example. It is an advantage, however, if a receiving device for a connection element is provided on each obstacle part, by means of which the obstacle part is connected permanently or detachably with the connection element, for example, by means of knots, a hook-and-loop connection, a hook and eye connection, a snap hook connection, a snap-button connection, or the like.

The receiving device can have an anchor ring for this purpose which is firmly connected with the obstacle part.

To increase the stability of the training apparatus it is advantageous if the receiving device forms a guide for the connection element, in particular in the form of an eye or guiding groove. Because of this, the connection element runs in the receiving device and prevents movements transverse to the extension direction of the training apparatus.

In this instance it is useful if the receiving device and/or the guide bears against a front face of the obstacle part which essentially is perpendicular to the longitudinal direction of the obstacle part, wherein the longitudinal direction of the obstacle part in the direction of its largest extension is defined, and/or is arranged on the surface of the obstacle part which contacts the floor. With obstacle parts having a round cross-section, the arrangement of receiving device and guide on the front faces is preferred; with obstacle parts having flat surfaces, an arrangement on the surface in contact with the floor is preferred.

It is conceivable in principle that the training apparatus is placed onto a floor of a hall or onto a lawn surface or onto a cinder or tartan track without being fastened. In a development of the invention it is provided, however, that the adjustment mechanism has a holding device for fixing the training apparatus stationary either detachably or permanently, wherein a change in the stationary fixing of the training apparatus in the extension direction will produce a change in the distances of the obstacle parts to one another, when viewed in the extension direction.

A development of the last-named inventive idea provides that the holding device has a tensioning device with which the distances, viewed in the extension direction, of the obstacle parts can be adjusted to one another. This makes it possible that the holding device must not always be moved in order to change the distances of the obstacle parts.

The holding device can in principle be designed as desired. For the stationary fixing of the training apparatus it is useful, however, if the holding device has tent pegs that can be pushed into the lawn surfaces, or has suction cups that can be fastened on smooth surfaces (such as the floor of a hall), or has snap hooks or hooks that can be hooked into stationary rings.

The obstacle parts can have any form, such as slalom pylons, for example. Obstacle parts are preferred, however, where the majority is essentially arranged parallel to one another relative to their respective longitudinal direction.

A development of the invention furthermore provides that the obstacle part has a cylindrical, round or rectangular, in particular Cartesian cross-sectional area. Finally it has ,proven to be advantageous if the obstacle part is a part made of foamed plastic, in particular polyethylene, polystyrene, PET, etc., or comprises a casing filled with a filling compound, in particular a synthetic material, sand, etc. in such cases an obstacle part can be produced inexpensively and the risk of injuries to users is also reduced.

To be able to change the height of the obstacle parts for training purposes or to be able to arrange obstacle parts of a different height consecutively, it is provided that an add-on component can be mounted onto the top side of the obstacle part. The add-on component can have a U-shape design, for example, and be placed onto or inserted on the obstacle part.

It can be advantageously provided that the add-on part can be detachably connected with the obstacle part with a mounting device. Examples for a simple and inexpensive mounting device can be a hook-and-loop connection or snap-buttons, which are arranged both on the top side of the obstacle parts as well as on a bottom side which is facing the add-on parts. By using mounting devices, the connection and/or holding force between the add-on parts and the assigned obstacle parts can be increased, so that the connected parts cannot be detached from one another easily and will also continue to stay connected if they are unintentionally contacted during the training.

It is also conceivable that several add-on parts can be stacked on top of each other or be connected together and be placed onto an obstacle part or can be mounted on the same. In this manner, the overall height of the obstacle element can be changed depending on the height of the add-on components and be adapted to the respective training requirements.

### BRIEF DESCRIPTION OF THE DRAWINGS

Further features, particulars and advantages of the invention result from the accompanying Claims and the drawings and subsequent description of preferred embodiments of the invention.

The drawings show:

FIG. 1 is a first embodiment of the training apparatus as taught by the invention with rectangular obstacle parts spaced at regular intervals to one another;

FIG. 2 is the training apparatus pursuant to FIG. 1 with a constantly increasing distance between the obstacle parts;

FIG. 3 is a detailed view of a receiving device with guide of the training apparatus pursuant to FIG. 1;

FIG. 4 is a second embodiment of the training apparatus as taught by the invention with cylindrical obstacle parts spaced at regular intervals to one another;

FIG. 5a is a rectangular obstacle part of the training apparatus as taught by the invention;

FIG. 5b is a wedge-shaped obstacle part of the training apparatus as taught by the invention;

FIG. 5c is a cylindrical obstacle part of the training apparatus as taught by the invention;

FIG. 6 is a rectangular obstacle part pursuant to FIG. 5a with an add-on part shown separately, and

FIG. 7 is the obstacle part shown in FIG. 6 with an add-on part attached to it.

### DETAILED DESCRIPTION

The Figures show a training apparatus, which is provided with the reference symbol 2 overall, for sports exercises, in particular running exercises. The training apparatus 2 is formed by a plurality of obstacle parts 4, which respectively have their maximum extension in a longitudinal direction 6. The obstacle parts 4 in each case are arranged individually in the extension direction 8 of the training apparatus 2, parallel to one another with reference to their respective longitudinal direction 6.

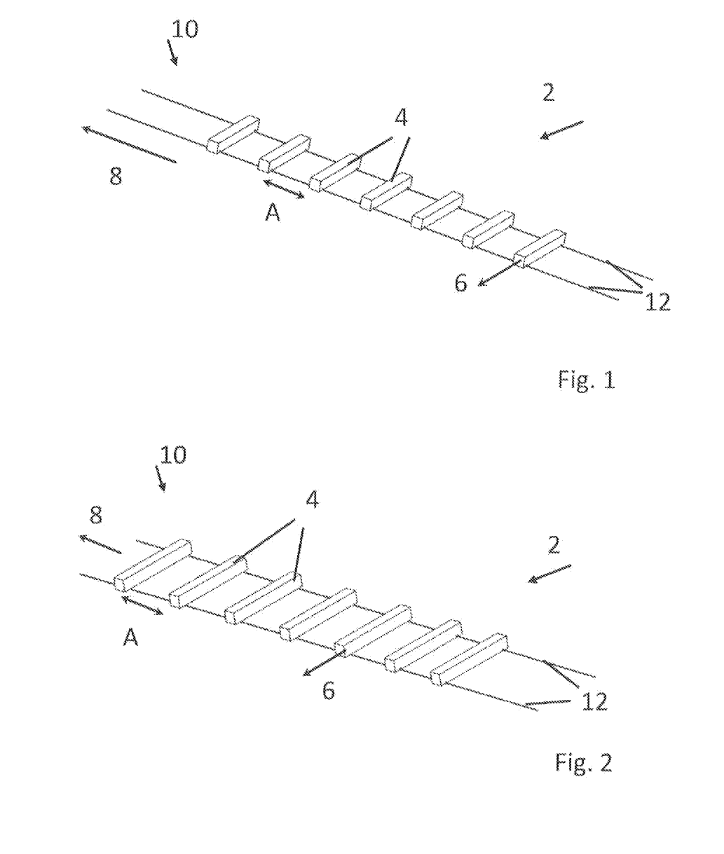

The training apparatus 2 moreover comprises an adjustment mechanism 10, which is formed by two connection elements 12 arranged in parallel to the extension direction 8 of the training apparatus 2. The connection elements 12 in FIG. 1 are realized in each case by a rubber cord which connects the individual obstacle parts 4 with one another. In the embodiment shown, the distances A of the individual obstacle parts 4 are equal to one another.

On the ends of the training apparatus 2, the connection elements 12 project beyond the obstacle parts 4, and there form a holding device 14 of the adjustment mechanism 10 for the training apparatus 2, with which the training apparatus can be arranged and fixed stationary.

The distances A between the obstacle parts 4 of the training apparatus 2 can be manually adjusted by the adjustment mechanism 10. This can be done by shifting the holding device 14 in the extension direction 8, for example, as a result of which the training apparatus 2 will be stretched or compressed, or by a tensioning device (not shown).

FIG. 2 shows the training apparatus 2 from FIG. 1, in which the distances A between the obstacle parts 4 were changed by means of the adjustment mechanism 10. In that context the distances A between the obstacle parts 4 increase constantly. This is achieved in that several. connection elements 12 are provided, which have an elasticity in each case that deviates from the other connection elements 12. As a result, when using the same action of force by the adjustment mechanism 10, this accomplishes a different extension of the distances A between the individual obstacle parts.

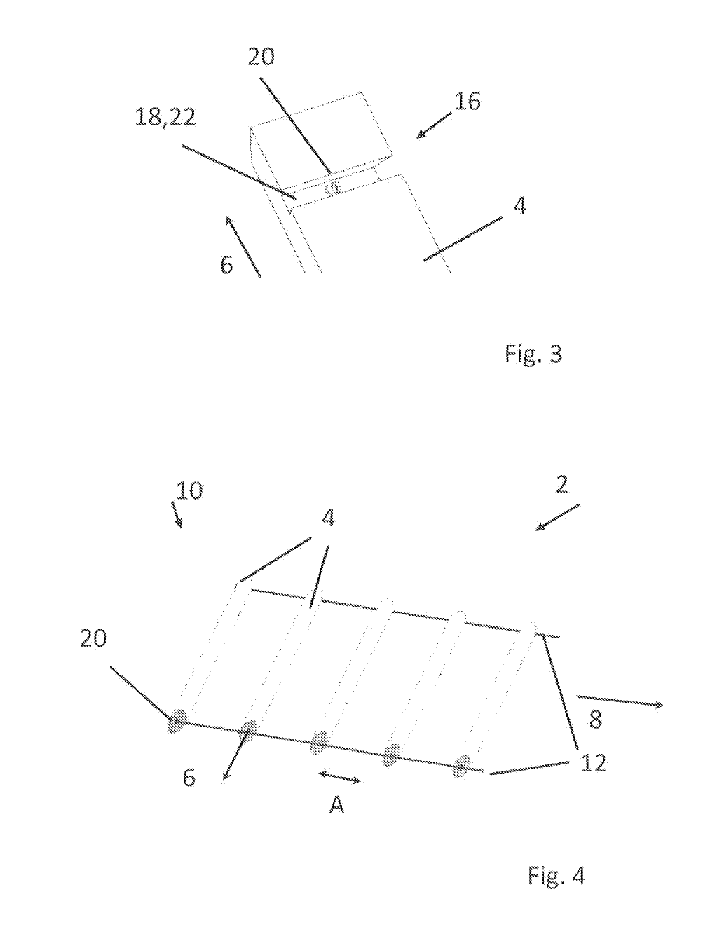

FIG. 3 shows an embodiment of the obstacle parts 4 of the training apparatus 2 on which a receiving device 16 with a guide 18 is provided on each obstacle part 4. The receiving device 16 and guide 18 are arranged on the surface of the obstacle part 4 which contacts the floor when the training apparatus 2 is used. The receiving device 16 is formed by an anchor ring 20 which is connected with the obstacle part 4. The anchor ring 20 is recessed in a guiding groove 22 which essentially extends in the extension direction 8 of the training apparatus. The connection element 12 designed as a rubber cord 10 can then be threaded through the anchor rings 20 of the obstacle parts 4 and connect the obstacle parts 4 in a simple manner, for example by knotting the connection element 12 together with the anchor ring.

FIG. 4 shows a further embodiment of the training apparatus 2 in which the obstacle parts 4 have a round cross-section i.e. they are shaped essentially cylindrically. Receiving device 16 and guide 18 are formed on the front faces of the obstacle part 4.

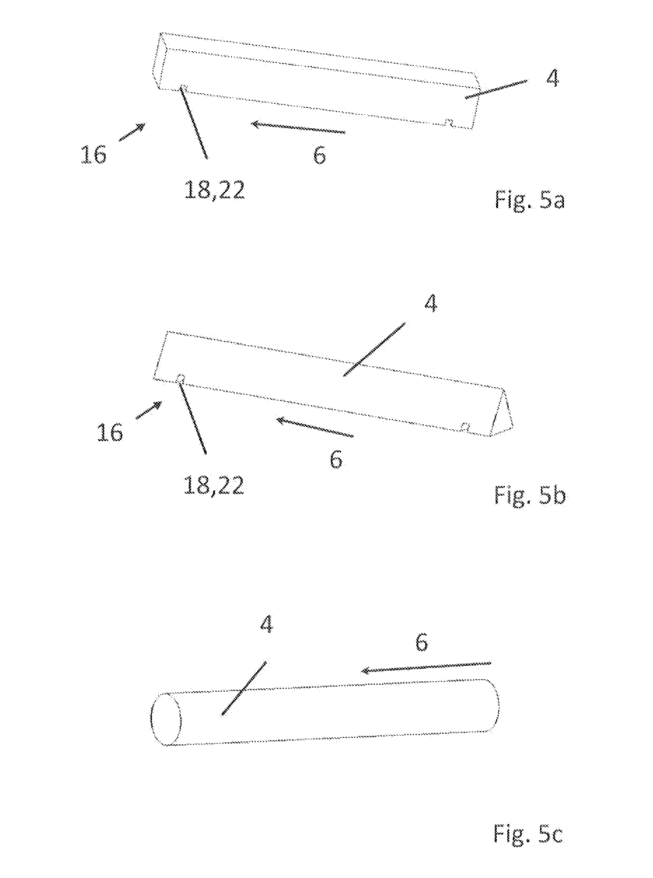

FIGS. 5a to 5c show preferred embodiments of the obstacle parts 4. FIG. 5a thus shows an obstacle part 4 with a rectangular cross-section, FIG. 5b shows an obstacle part 4 with a triangular cross-section. With these two, it would be expedient to provide the guide 18 and the receiving device 16 on a flat surface facing the floor.

FIG. 5c shows an embodiment with a round obstacle part 4, where it would be useful to arrange the receiving device 16 and the guide 18 on the front face of the obstacle part 4. The following briefly describes the functionality of the training apparatus 2. To set up the training apparatus 2, the connection elements 12 are threaded through the receiving devices 22 formed as anchor rings 22 and are fixed on the anchor rings 22. This can be clone by means of knotting, or by means of hooks or snap hooks (not shown). For this purpose, a distance A is adjusted between the obstacle parts 4.

To increase the stability of the training apparatus 2, two connection elements 12 are provided which are respectively arranged on one end of the obstacle parts 4. There, they run through the guides 18 formed by the guide grooves 22, as a result of which they keep the training apparatus 2 relative to a shift transverse to the extension direction 8 of the training apparatus 2. As a result, the obstacle parts 4 are moreover aligned and held parallel relative to their longitudinal direction 6.

In order to fix the training apparatus 2 to be stationary, the connection elements 12 are forming the holding device 14 on the ends of the training apparatus 2 and are connected with the floor on which the training apparatus 2 rests by suitable means (tent pegs, suction cups, snap hooks, etc.).

To change the distances A between the obstacle parts 4, the stationary fixation can be shifted in the extension direction 8. As a result, the connection elements 12 will be additionally stretched or relaxed. However, a tensioning device (not illustrated in the Figures) can also be provided, which tensions or relaxes the connection elements 12 without having to relocate the holding device 14.

It is particularly advantageous that the distance A between two obstacle parts 4 can be determined easily and manually by means of the adjustment mechanism 10, which reduces the slippage of the obstacle parts 4 when a user 10 bumps against it.

FIGS. 6 and 7 show an example of a Cartesian obstacle part 4 with a rectangular cross-section pursuant to FIG. 5a, onto which an add-on part 24 can be mounted. The add-on part 24 has a shape that matches the obstacle part 4. In particular, the two side faces of the obstacle part 4 and of the add-on part 24 which are facing each other are essentially flat and of the same size. But other shapes can also be used, however.

The add-on part 24 and the obstacle part 4 are detachably connected with each other by two mounting devices 26, each of which are arranged in the vicinity of the two ends of the obstacle part 4. In the example of the embodiment illustrated pursuant to FIGS. 6 and 7, the mounting device 26 consists of a Velcro strip. However, also snap-buttons or latching elements can be used as mounting device in order to generate a detachable connection, but which must not detach during any unintentional contact with the add-on part during the training.

1. A training apparatus for sports exercises, in particular for running exercises, with a plurality of obstacle parts each individually arranged in an extension direction of the training apparatus, wherein the training apparatus additionally has an adjustment mechanism for manually adjusting the distance, viewed in the extension direction, between an obstacle part and at least one further, adjacent obstacle part, and the adjustment mechanism has at least one connection element which interconnects all the obstacle parts or at least two reciprocally adjacent obstacle parts , wherein the connection element is preferably formed by at least one elastically ductile cord.

2. The training apparatus according to claim 1, wherein the distance between the obstacle parts to one another, viewed in the extension direction, is constant or deviates from one another.

3. The training apparatus according to claim 1, wherein on each obstacle part a receiving device is provided for a connection element of the adjustment mechanism, by means of which the obstacle part is connected with the connection element permanently or detachably.

4. The training apparatus according to claim 3, wherein the receiving device includes an anchor ring (20).

5. The training apparatus according to claim 3, wherein the receiving device forms a guide for the connection element.

6. The training apparatus according to claim 4, wherein the receiving device and/or the guide bears against a front face of the obstacle part, which is perpendicular to the a longitudinal direction of the obstacle part, wherein the longitudinal direction of the obstacle part is defined in the a direction of its largest extension, and/or is arranged on the surface of the obstacle part bearing against the floor.

7. The training apparatus according to claim 1, wherein the adjustment mechanism has a holding device for fixing the training apparatus stationary detachable or permanently, wherein a change of the stationary fixing of the training apparatus in the extension direction will produce a change of the distances of the obstacle parts to one another, when viewed in the extension direction.

8. The training apparatus according to claim 7, wherein the holding device has a tensioning device, with which distances of the obstacle parts can be adjusted to one another, seen in the extension direction.

9. The training apparatus according to claim 7, wherein the holding device for the stationary fixing of the training apparatus has tent pegs which can be pushed into lawn surfaces, suction cups that can be fastened onto smooth surfaces, or has snap hooks or hooks that can be hooked into stationary rings.

10. The training apparatus according to claim 1, wherein the plurality of obstacle parts are essentially arranged parallel to one another relative to their respective longitudinal direction.

11. The training apparatus according to claim 1, wherein the adjustment mechanism has at least two connection elements running in parallel to one another, which are preferably connected with same on the ends of the respective obstacle part, when viewed in the longitudinal direction.

12. The training apparatus according to claim 1, wherein the obstacle part has a cylindrical, round or rectangular, in particular Cartesian cross-sectional area.

13. The training apparatus according to claim 1, wherein the obstacle part comprises a part made of foamed plastic, in particular polyethylene, polystyrene, PET, etc., or a casing filled with a filling compound, in particular a synthetic material, sand, etc.

14. The training apparatus according to claim 1, wherein an add-on part can be mounted on one top side of the obstacle part.

15. The training apparatus according to claim 16, wherein the add-on part can be connected with a mounting device (26) detachably with the obstacle part.
